(19) United States
(12) Patent Application Publication
(10) Pub. No.: US 2025/0291598 A1
(43) Pub. Date: Sep. 18, 2025

(54) INSTRUCTION FETCH GROUP EXIT POINT PREDICTION USING OFFSET COUNTERS

(71) Applicant: Tenstorrent USA, Inc., Austin, TX (US)

(72) Inventors: Vignyan Kothinti, Redmond, WA (US); Soundharya Balasubramanian, San Jose, CA (US); Ashok T Venkatachar, Fremont, CA (US); Yasuo Ishii, Palo Alto, CA (US); Wei-han Lien, Saratoga, CA (US)

(21) Appl. No.: 18/759,786

(22) Filed: Jun. 28, 2024

Related U.S. Application Data
(60) Provisional application No. 63/566,302, filed on Mar. 17, 2024.

(51) Int. Cl. G06F 9/38; G06F 9/32

(52) U.S. Cl. CPC G06F 9/3806; G06F 9/321; G06F 9/3844

(57) ABSTRACT

Systems and methods related to branch prediction circuits and instruction fetch circuits in computer processors are disclosed herein. A branch prediction circuit and an instruction fetch circuit may operate in combination to fetch a group of instructions from a memory. A counter and an offset may be associated with the fetch group and may form a prediction entry in a table of a prediction circuit. The counter may represent the longest consecutive number of uses of an instruction as the exit point of the branch. The offset may represent the instruction in the fetch group that is associated with the current longest consecutive number of uses as the exit point of the branch. The processor may predict that a branching instruction in the fetch group will be used to branch the program based on the counter and the offset. The fetch circuit may prefetch an instruction based on the prediction.

### CROSS REFERENCE TO RELATED APPLICATIONS

This application claims the benefit of U.S. Provisional Patent Application No. 63/566,302, filed Mar. 17, 2024, which is incorporated by reference herein in its entirety for all purposes.

### BACKGROUND

Computer processors execute programs through the interpretation and execution of a sequence of instructions. Branching instructions play a crucial role in directing the flow of execution based on certain conditions. When a branching instruction is encountered, the processor needs to predict the outcome of the branch (whether it will be taken or not) to continue fetching and executing instructions efficiently. Processors employ sophisticated branch prediction mechanisms, such as Tagged Geometric History Length (TAGE) predictors, to anticipate the likely outcome of branches. If the prediction is correct, the processor continues fetching and executing instructions along the predicted path. However, if the prediction is incorrect, a process known as a branch misprediction occurs, leading to a pipeline stall and the discarding of incorrectly fetched instructions. This interruption in the pipeline may impact performance, making accurate branch prediction crucial for optimizing processor efficiency and overall program execution speed.

Advanced techniques such as TAGE predictors are often used by branch prediction circuits in modern processors. TAGE is a sophisticated branch predictor designed to enhance the accuracy of predicting branch outcomes. It utilizes a set of tables with varying geometric history lengths, allowing it to adapt to different patterns in a program's control flow. Each table corresponds to a specific history length, capturing both short-term and long-term dependencies in the branch behavior. The TAGE predictor employs a select function to combine predictions from these tables, assigning different weights to each based on their effectiveness. This approach significantly improves the overall accuracy of branch prediction, reducing the likelihood of branch mispredictions and resulting in more efficient program execution. Consequently, processors equipped with TAGE predictors may better navigate branching instructions, mitigating the performance impact of mispredictions and ultimately enhancing the overall speed of program execution.

### SUMMARY

Systems and methods related to branch prediction circuits and instruction fetch circuits in computer processors are disclosed herein. A branch prediction circuit and an instruction fetch circuit of a processor may operate in combination during execution of a program to fetch a group of instructions, in a fetch group, from an instruction memory. A counter and an offset may be associated with the fetch group and may form a prediction entry in a table of a prediction circuit. The counter may keep track of the longest consecutive number of uses of an instruction as the exit point of the branch. The offset may be used to represent the instruction in the fetch group that is associated with the current longest consecutive number of uses as the exit point of the branch. The processor may predict that a branching instruction in the fetch group will be used to branch the program based on the counter and the offset. The fetch circuit may prefetch at least one instruction based on the prediction. The counter may count only the number of times a branch has been taken or may count both the number of times a branch is taken and a number of times a branch is not taken.

In specific embodiments of the invention, a method, in which each step is conducted by a branch prediction circuit and an instruction fetch circuit operating in combination in a computer processor that is executing a program, is provided. The method comprises: fetching a group of instructions, in a fetch group, from an instruction memory; associating a counter and an offset with the fetch group; predicting, using the counter and the offset, that a branching instruction in the fetch group will be used to branch the program; and prefetching at least one instruction indicated by the branching instruction.

In specific embodiments of the invention, a processor is provided. The processor comprises: a branch prediction circuit; an instruction fetch circuit, wherein the instruction fetch circuit fetches a group of instructions, in a fetch group, from an instruction memory; and a counter and an offset associated with the fetch group, wherein the counter and the offset are used to predict that a branching instruction in the fetch group will be used to branch a program, and at least one instruction indicated by the branching instruction is prefetched.

In specific embodiments of the invention, a non-transitory computer-readable medium storing instructions, which when executed by a processor cause the processor to conduct a method in which each step is conducted by a branch prediction circuit and an instruction fetch circuit operating in combination in a computer processor that is executing a program, is provided. The method comprises: fetching a group of instructions, in a fetch group, from an instruction memory; associating a counter and an offset with the fetch group; predicting, using the counter and the offset, that a branching instruction in the fetch group will be used to branch the program; and prefetching at least one instruction indicated by the branching instruction.

### BRIEF DESCRIPTION OF THE DRAWINGS

The accompanying drawings illustrate various embodiments of systems, methods, and various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides a block diagram in accordance with the related art.

FIG. 2 provides a block diagram in accordance with specific embodiments of the inventions disclosed herein.

FIG. 3 provides a comparison of the prediction entry in FIG. 1 and the prediction entry in FIG. 2 in accordance with specific embodiments of the inventions disclosed herein.

FIG. 4 provides an operation of a branch predictor circuit in accordance with specific embodiments of the inventions disclosed herein.

FIG. 5 provides a method using a first counter associated with an offset in accordance with specific embodiments of the inventions disclosed herein.

FIG. 6 provides a method using a second counter in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for instruction fetch group exit point prediction using offset counters in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Systems and methods related to branch prediction circuits and instruction fetch circuits in computer processors are disclosed herein. In specific embodiments of the invention disclosed herein, a branch prediction circuit and an instruction fetch circuit of a processor operate in combination during execution of a program to fetch a group of instructions, in a fetch group, from an instruction memory, and to predict that a branching instruction in the fetch group will be used to branch the program. The term fetch group is used here to refer to the fact that a group of instructions is fetched from instruction memory in bulk instead of one at a time. The point at which the program branches may be referred to as the exit point of the fetch group. Upon predicting that a branching instruction will be used to branch the program, the fetch circuit can prefetch at least one instruction which is indicated by the branching instruction. The term branching instruction is used herein to refer to an instruction which may lead to branching of a program based on certain conditions. As such, a fetch group with three branching instructions includes three potential exit points, of which generally only one is used when the program is actually executed and the conditions that lead to branching by the branching instructions are actually evaluated.

In specific embodiments of the invention disclosed herein, the branch prediction circuit can predict that a branching instruction will be used to branch the program using only a counter and an offset associated with the fetch group. The counter and the offset may be associated with the fetch group in a buffer of the branch prediction circuit. The buffer may include a table of values. The table may be part of a TAGE prediction circuit of the branch prediction circuit. The counter and the offset may form a prediction entry which is associated with the fetch group.

In specific embodiments of the invention, the use of a compact prediction entry in the form of a counter and an offset provides significant benefits when compared to prior art approaches. Prior art approaches include those in which a prediction entry for a given fetch group comprises a counter for each of the branching instructions in a fetch group. Given a 32-Byte fetch group comprising 16 2-Byte branching instructions (and thereby 16 potential exit points) and a branch predictor circuit that requires a count of up to 16 for branch predictions, the resulting predictor entry must be 48-bits. In specific embodiments, the counter will include a bit for indicating whether or not a branch is taken, and the remaining bits will count the number of times the branch was taken or not taken (e.g., a 3-bit counter can count 4 times the branch was taken and 4 times it was not taken). Given a 64-Byte fetch group comprising 32 2-Byte branching instructions, and a 3-bit counter per branch, the resulting predictor entry must be 96 bits per fetch group. As a large number of fetch groups must be associated with predictor entries in order for the branch predictor circuit to operate efficiently for a given program, the data structure required to hold all of the entries may be very large. This may reduce the speed at which branch predictions may be made and uses up vital space in the execution area of the processor.

Using specific approaches disclosed herein, a single 3-bit value can be used for the offset to indicate which of the 16 instructions a single counter value is associated with. Using specific embodiments of this approach, only the largest counter value is retained, which results in a lower performance accuracy of the branch predictor. The counter may be a counter that counts the number of times a branch has been taken or counts the number of times a branch is taken and a number of times a branch is not taken (e.g., by using one bit to identify which quantity is being counted). The inventors have found that the decrease in accuracy is unexpectedly tolerable when compared with the amount of data saved from needing to be stored in database associated with the branch predictor. The improvement is only more pronounced for larger fetch group sizes. For example, increasing the fetch group size from 32 Bytes to 64 Bytes would require only 1 additional bit for the counter while the typical approach would require twice the number of bits. In specific embodiments of the invention, the offset may comprise sufficient bits to represent each instruction in the fetch group. For example, if there were 16 instructions in a fetch group, the offset could be a 3-bit entry that could encode a value capable of identifying each instruction in the fetch group. In specific embodiments, each branching instruction in the fetch group could be associated with a value of the offset.

In specific embodiments of the invention, each fetch group can also be associated with additional data in addition to the offset and the counter. For example, the fetch group can include a hysteresis counter which counts a number of times that one or more branches besides the branch that is currently being counted, has been taken. The hysteresis counter can be compared to a threshold value that is a fixed value to determine if a different branch in the fetch group should be tracked by the counter instead. The hysteresis counter can be modified by being incremented or decremented depending upon the style of counter and the threshold (e.g., a hysteresis counter can equivalently count up from zero to a threshold of five or down from five to a threshold of zero). For example, if the hysteresis counter reaches a value of 5, meaning that a different branch was taken 5 times, then the counter and offset value can switch to keep track of a different branch. As another example, the fetch group can include a specialized threshold value that can be used in a comparison with the threshold value to determine when the current branch should no longer be the branch that is currently being tracked. The threshold value could be set independently for different fetch groups and be stored in a table in association with the fetch group. The threshold value could be computed dynamically for a given fetch group either based on data that was associated with the fetch group or based on the instructions in the fetch group themselves. In such embodiments, the threshold value would not necessarily need to be stored with the fetch group as it could be used in a comparison with the hysteresis value after being computed dynamically and could then be discarded. However, in alternative embodiments, the threshold will be dynamically computed and then stored in association with the fetch group.

In specific embodiments of the invention, each fetch group may be represented in multiple tables. For example, in a TAGE implementation each fetch group may have a prediction entry in one of multiple tables. The prediction of the highest-priority predictor can be used to predict the outcome of the fetch group. In specific embodiments of the invention, the highest-priority rule can also be overruled by a predictor which indicates the branch is not taken (e.g., a counter with a nonzero value for a count of times a branch is not taken or a counter with a value of zero for the number of times a branch is taken). Accordingly, in specific embodiments a given fetch group may have a counter and offset stored as a prediction entry in multiple tables. If table-0 predicts ‘Taken, branch-offset 3’ and table-1 predicts ‘Taken, branch-offset 4’ then the predicted outcome is ‘Taken, branch-offset 4’. Using the same specific embodiment, if table-0 predicts ‘Taken, branch-offset 3’ and table-1 predicts ‘Taken, branch-offset 4’ and table-3 predicts ‘not-taken,-NA-’, then the overall predicted outcome is not taken.

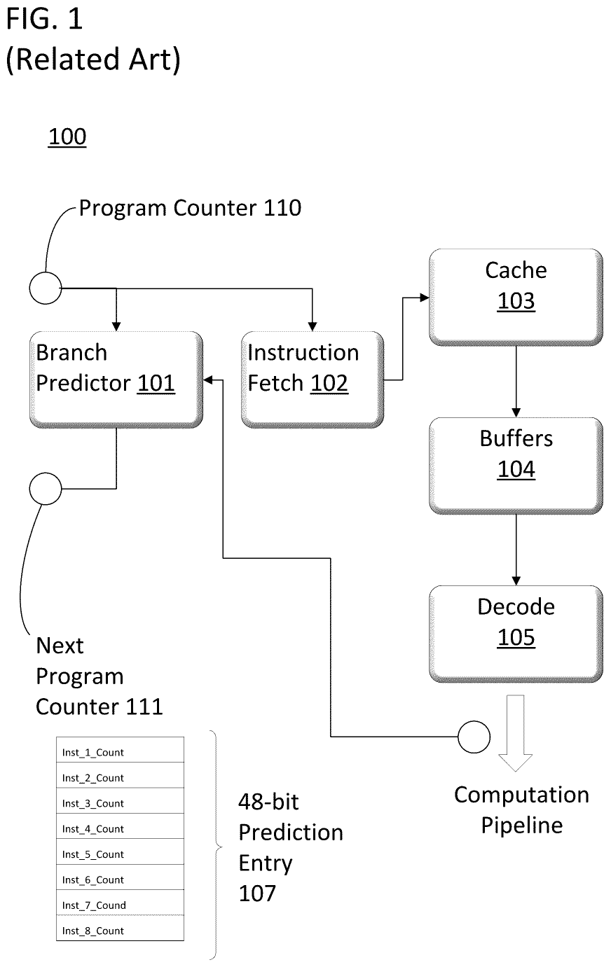

FIG. 1 illustrates a block diagram 100 of a branch predictor circuit 101 and an instruction fetch circuit 102 operating in combination to execute a program. The instruction fetch circuit 102 uses access to program counter 110 to move instructions from instruction cache 103 to instruction buffers 104, where the instructions are held prior to being sent to decode logic 105 and then on to the computation pipeline for execution. Branch predictor circuit 101 also has access to program counter 110 and includes a set of tables with prediction entries that are used to predict branching instructions for the purpose of producing next program counter 111. Next program counter 111 may then be used to prefetch instructions for execution on the assumption that the predicted branch in the program will be taken. Branch predictor circuit 101 may accomplish this using tables with prediction entries. The prediction entries may be associated with a fetch group. Accordingly, when a fetch group associated with a program counter value for program counter 110 is fetched, branch predictor circuit 101 may recall the values for the prediction entries associated with that fetch group. Branch predictor circuit 101 may then use those prediction entries to produce the next program counter 111.

In standard approaches, the prediction entries for a given fetch group include a counter for each of the branching instructions in the fetch group. The counter may be the kind of counter which includes a bit to indicate if a branch has been taken or not. If none of the counters for the fetch group indicate that a branch is taken, then it will be predicted that no branch should be taken. Since it may be unknown how many instructions in the fetch group can be branching instructions, and it is possible that all of the instructions in a fetch group may be branching instructions, a given fetch group may need to be associated with a set of prediction entries equal to the number of instructions in the fetch group where each prediction entry requires a number of bits set by the count scheme of a given implementation. The count scheme will keep track of how many times a specific branching instruction in the fetch group has been used as the exit point of the fetch group. In specific embodiments, the count scheme may also keep track of how many times a specific branching instruction in the fetch group has not been taken. The counts for each of the instructions may then be used in the future to determine, based on experience, which of the instructions is the most likely to be the exit point of the fetch group when the fetch group is fetched again at a later time. In the illustrated example, the count scheme may allow for 64 total counts of each instruction and the fetch group includes 8 instructions. Since it takes 6 bits to represent 64 total counts the resulting prediction entry 107 is 48-bits as each of the 8 instructions is associated with a 6-bit counter. Given that each fetch group used in a program will have such a prediction entry the data structure required to store all the required data may be immense.

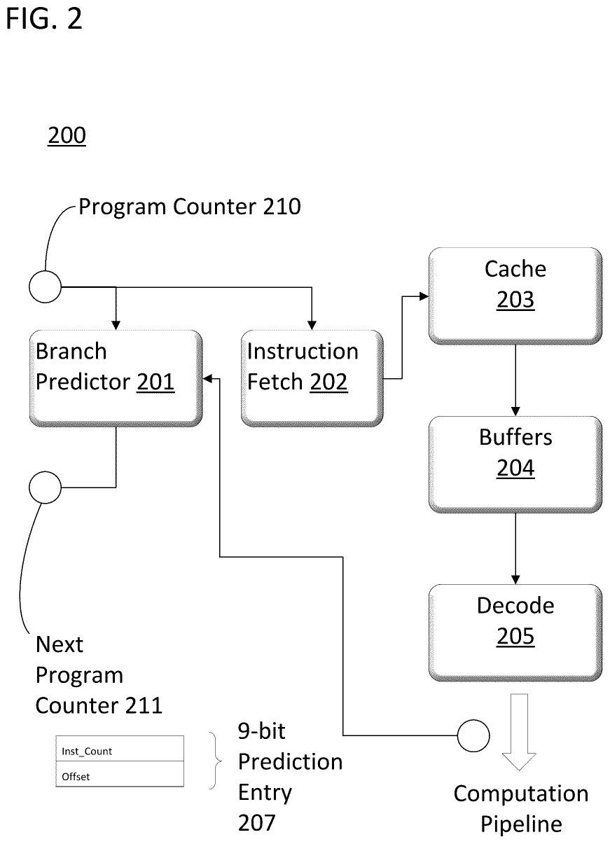

FIG. 2 illustrates a block diagram 200 of a branch predictor circuit 201 and an instruction fetch circuit 202 operating in combination to execute a program. The instruction fetch circuit 202 uses access to program counter 210 to move instructions from instruction cache 203 to instruction buffers 204, where the instructions are held prior to being sent to decode logic 205 and then on to the computation pipeline for execution. Branch predictor circuit 201 also has access to program counter 210 and includes a set of tables with prediction entries that are used to predict branching instructions for the purpose of producing next program counter 211. The tables may include a table used for the purposes of predicting branching instructions in a program. The table may be a TAGE table. Next program counter 211 may then be used to prefetch instructions for execution on the assumption that the predicted branch in the program will be taken. Branch predictor circuit 201 may accomplish this using tables with prediction entries. The prediction entries may be associated with a fetch group. Accordingly, when a fetch group associated with a program counter value for program counter 210 is fetched, branch predictor circuit 201 may recall the values for the prediction entries associated with that fetch group. Branch predictor circuit 201 may then use those prediction entries to produce the next program counter 211.

In contrast to the approach described with reference to FIG. 1, the prediction entry 207 in FIG. 2 does not include a counter for every instruction in the instruction group. The fetch groups used in block diagram 200 may be the same 8-instruction sized fetch groups as were used in block diagram 200. However, the prediction entry associated with each fetch group may instead be an 18-bit data structure with a 6-bit counter and a 3-bit offset. The 3-bit offset may be used to represent the instruction in the fetch group that is associated with the current longest consecutive number of uses as the exit point of the branch. The 6-bit counter may keep track of the longest consecutive number of uses of an instruction as the exit point of the branch. For example, if the first instruction in the fetch group had been the exit point of the fetch group the last four times the fetch group was executed, the offset could be a value of 000 which is associated with the first instruction, and the instruction counter could be a value of 00011 which is associated with four consecutive exit points. The value of the offset could, in this way, indicate which instruction in the fetch group the counter is associated with. Accordingly, the offset and the number of instructions in the fetch group may be represented by a same number of bits. In the illustrated case, the total number of bits is 9 for the same sized fetch group as in FIG. 1, resulting in a major decrease in the required size of the data structure used to store the prediction entries for the program.

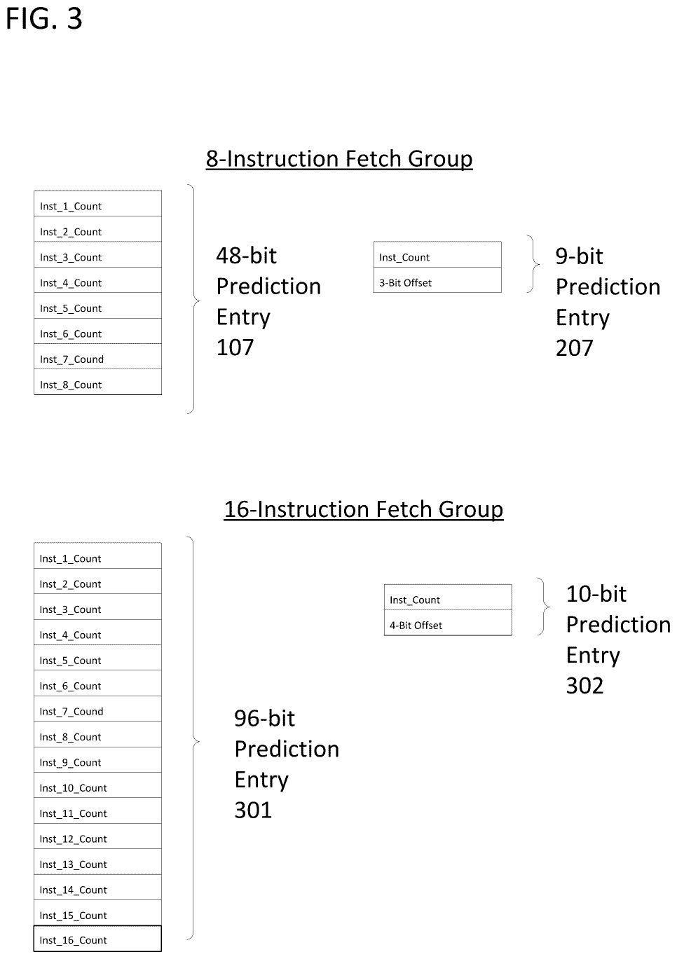

As illustrated in FIG. 3, the benefit of specific embodiments of the invention disclosed herein increases dramatically with the size of the fetch group. FIG. 3 includes a comparison of the size of the prediction entry 107 and prediction entry 207 from the examples above for an 8-instruction fetch group. In situations in which the fetch group doubles in size, such as to a 16-instruction fetch group, the approach described with reference to FIG. 1 will require a 96-bit prediction entry 301. This is because each additional instruction results in another 6-bit counter that must be tracked and stored for the additional 8 instructions. However, the approach described with reference to FIG. 2 will only require one additional bit to form a 10-bit prediction entry 302. This is because all that needs to be increased is the number of instructions that can be represented by the offset. As adding another bit will double the number of instructions that can be represented, all that is required is the addition of this single bit. Again, give that a typical program will require the utilization of thousands or hundreds of thousands of fetch groups, the benefit realized in terms of reduced space of the tables required by the prediction circuits, or increased availability for other information in those tables, may be significant.

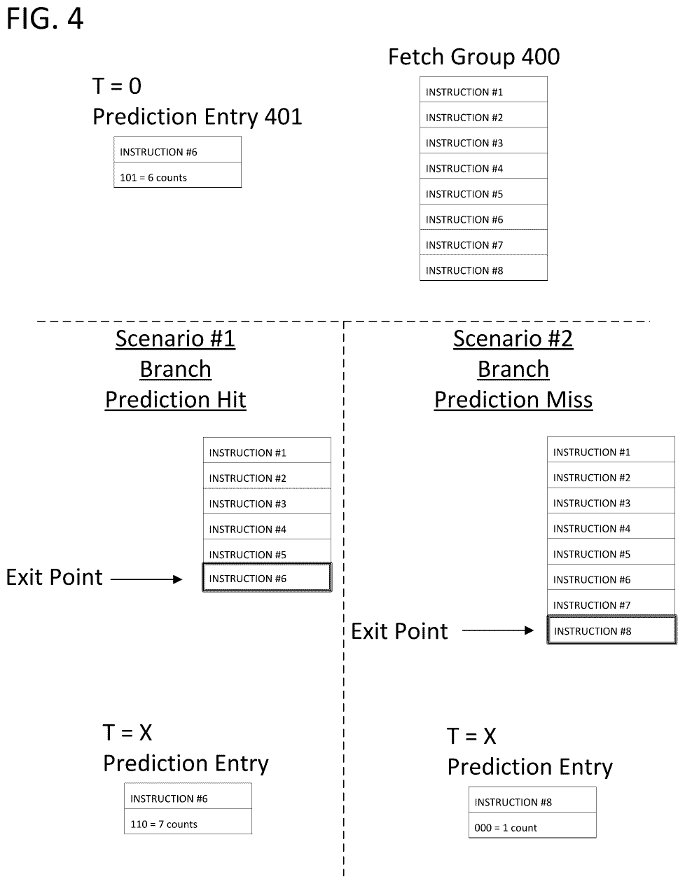

FIG. 4 represents the operation of a branch predictor circuit in updating the prediction entries for a given fetch group in accordance with specific embodiments of the inventions disclosed herein. The branch predictor circuit may associate a fetch group 400 with a prediction entry 401 in a table of prediction entries available to the branch predictor circuit. The prediction entry 401 is shown at time zero when fetch group 400 is fetched from instruction memory. The offset for prediction entry 401 is associated with instruction 6 in fetch group 400 and the counter is set to a value of 101 indicating that the last 6 times the fetch group was retrieved from memory, instruction 6 was the exit point of the branch. Accordingly, the branch predictor circuit will predict that instruction 6 will again be the exit point of the fetch group and will use that information to set the next program counter value and prefetch instructions based on that prediction.

FIG. 4 then splits into two different scenarios. In one scenario there is a branch prediction hit as instruction 6 is again the exit point of the fetch group. In a second scenario there is a branch prediction miss as instruction 8 is instead the exit point of the fetch group. The prediction entry is then shown at time X which is sometime after time zero when the prediction entry has been updated in both scenarios. In the first scenario, the offset value is left unchanged because instruction 6 should still be associated with the value of the counter. However, the counter value has been incremented by one to a value of 110 to indicate that the last 7 times the fetch group was fetched instruction 6 was the exit point of the fetch group. In the second scenario, the offset value is changed so that it is associated with instruction 8 since instruction 8 is the instruction that is now associated with the counter. Additionally, the counter value is reset to value of 000 to indicate that the last time the fetch group was fetched instruction 8 was the exit point of the fetch group. Subsequently, the illustrated process may be repeated the next time the fetch group is fetched from memory but with the values for the prediction entry at time X replacing those at time 0. In an alternative scenario, which is not illustrated, and which would be executed by a different embodiment, on a branch prediction miss, a hysteresis counter could be incremented, or the counter could be decremented by one. The offset would then remain the same until additional branch prediction misses caused the hysteresis counter to exceed a threshold or until additional branch prediction misses caused the counter to be decremented below a threshold. Subsequently, the offset and counter could be modified so that a new and different exit points was being traced by the prediction entry as in the second scenario of FIG. 4.

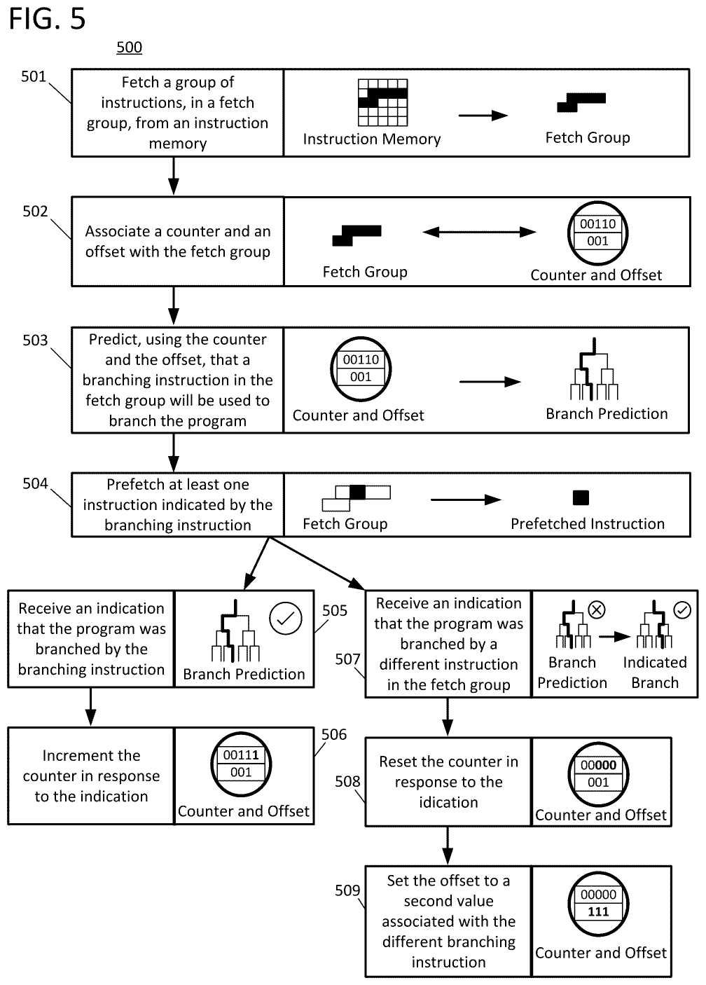

FIG. 5 provides method 500 in accordance with specific embodiments of the invention. Each step of the method may be conducted by a branch prediction circuit and an instruction fetch circuit operating in combination in a computer processor that is executing a program.

At 501, the method may begin with fetching a group of instructions, in a fetch group, from an instruction memory. The fetched instructions may be sent from an instruction memory to a buffer or set of buffers in an execution area of the processor where they may be staged for execution by the computation pipeline of the processor. The fetch group may have a number of instructions that is known by the branch predictor circuit and the instruction fetch circuit.

The fetch group may be associated with (e.g., uniquely associated with) a prediction entry in a table that is accessible to or part of the branch predictor circuit. The table may be a register file or other memory storage element. The table may be in the execution area of the processor. The prediction entry may include the counter and the offset. The counter may keep track of how many times a given instruction in the fetch group lead to a branching of the program (e.g., how many times it has consecutively served as the exit point from the fetch group). The offset may keep track of which instruction in the fetch group is currently associated with the counter (e.g., which instruction has served as the exit point from the fetch group the last time or number of times the fetch group was executed).

At 502, a counter and an offset may be associated with the fetch group. As stated previously, the counter and the offset may form a prediction entry such that this step comprises associating a prediction entry with the fetch group. This step may be conducted by storing the counter and the offset at a specific address in a data structure such as a table associated with a TAGE or other branch predictor system. The location of the counter and the offset may associate the values with a specific fetch group. This process may also include storing a tag that identifies the fetch group and associating the fetch group with the counter and the offset via the tag. The tag, the offset, and the counter may all be stored in a table in association together. Subsequently, when the same fetch group is retrieved from memory, the branch predictor circuitry may search for the tag associated with the fetch group and retrieve the counter and the offset, and any other data associated with the fetch group if present. The tag may be generated during execution of the program and be associated with the fetch group in various ways such as by being a hash of the instructions in the fetch group or portions thereof.

At 503, the processor may predict, using the counter and the offset, that a branching instruction in the fetch group will be used to branch the program. There are numerous ways in which a branch predictor circuit may predict which instruction in a fetch group will be used to branch a program. A branch predictor circuit employs various strategies to predict the outcome of branch instructions in a program, which may be crucial for maintaining efficient processor pipelines. One technique is to use pattern history tables (PHT) that store the recent history of branch outcomes, allowing the predictor to identify recurring patterns in the program's control flow. The offset, counter, and prediction entries mentioned above may populate a set of PHTs and be used for this purpose. Another method involves the use of correlating predictors, which consider the relationship between multiple branches and their outcomes. Additionally, tournament predictors combine the predictions of multiple simpler predictors, selecting the most accurate one based on their historical performance. More advanced predictors, such as TAGE predictors, utilize multiple tables with different geometric history lengths, capturing both short-term and long-term patterns in branch behavior. These predictors often incorporate sophisticated algorithms, like gselect functions, to determine the contribution of each predictor to the final branch prediction. The offset, counter, and prediction entries mentioned above may be used in these functions. The collective use of these techniques may help a processor anticipate branch outcomes, reduce pipeline stalls and optimize overall program execution speed. In a specific example, the branch predictor will utilize the offset and the counter to determine which instruction will branch the program. This data may be used in combination with the approaches described above or in a basic approach in which the instruction associated with the offset is automatically selected as the likely instruction to lead to a branch of the program.

At 504, at least one instruction indicated by the branching instruction may be prefetched (e.g., by a branch predictor circuit). The branch predictor circuit may store the value of the program counter that results from different branching instructions and provide that program counter value to an instruction prefect circuit in order to execute this step. With reference back to FIG. 2, 504 may involve branch predictor circuit 201 providing next program counter 211, to an instruction prefetch circuit which brings the implicated instructions from a larger, and possibly slower, instruction memory to cache 203.

In specific embodiments, the offset may comprise sufficient bits to represent each instruction in the fetch group. For example, the offset may be an n-bit data value that is used to represent n² different instructions in a fetch group. Accordingly, the instruction that is predicted to be a branching instruction may be associated with a value of the offset. For example, if the second instruction in a 16 instruction fetch group was predicted to be the branching instruction, the offset could have value of 001 where the value 000 represented the first instruction in the fetch group. The offset is, in this example, an offset from the first instruction in the fetch group. In alternative approaches the offset could be an offset from the final instruction in the fetch group. In alternative approaches, the offset may comprise sufficient bits to represent each potential branching instruction in the fetch group. For example, if it were known that only certain instructions in the fetch group were branching instructions, the offset would only need to comprise sufficient bits to represent each of those branching instructions. In these embodiments, the prediction entry for the fetch group could include an encoding of which instructions in the fetch group were branching instructions, and this encoding could then be used in combination with the offset to predict which instruction in the fetch group was associated with the counter value.

In specific embodiments, the method may include different steps depending upon whether the branching prediction circuit was correct in its prediction, such as performing 505 and 506 if the branching prediction circuit was correct or performing 507, 508, and 509 if the branching prediction circuit was not correct.

At 505, method 500 may include receiving an indication that the program was branched by the branching instruction. In other words, an indication could be received by circuitry such as the branch prediction circuit that the predicted branch was taken. The indication could be received from the computation pipeline of the processor. The process of 505 may be conducted in accordance with the first scenario from FIG. 4. Accordingly, at 506, the method 500 may further include incrementing the counter in response to the indication.

As an alternative, the method 500 may include, at 507, receiving an indication that the program was branched by a different branching instruction in the fetch group. In other words, an indication could be received by circuitry such as the branch prediction circuit that the predicted branch was not taken, or more generally that a different branch was taken. The indication could be received from the computation pipeline of the processor. The step of 507 may be conducted in accordance with the second scenario from FIG. 4. In alternative embodiments, step 507 could involve incrementing a hysteresis counter and comparing the value to a threshold value prior to step 508. Accordingly, at 508, the method may further include resetting the counter in response to the indication and, at 509, setting the offset to a second value associated with the different branching instruction. In alternative approaches, this step can more generally involve lowering the counter to a lower value. For example, if the indication indicated that an 8^{th} instruction in the fetch group was the instruction that actually led to a branch of the program, the offset could be set to a value associated with the eight instruction and the counter could be reset to zero. In other examples, the counter could be reduced to a lower value associated with an estimate for how likely the 8^{th} instruction in the fetch group led to a branch of the program.

In specific embodiments the fetch group may have a number of instructions that is at least 4. In alternative embodiments, the fetch group may have a number of instructions that is at least 16. In specific embodiments, the fetch group may have 32, or 64 instructions. The counter, the offset, and any other data such as a hysteresis counter may form a branch predictor for the fetch group. The offset may be less than or equal to a number of bits required to represent the number of instructions. Given the examples above, the offset could be a 2-bit number, a 3-bit number, a 4-bit number, or a 5-bit number. In specific embodiments the counter can be a 3-bit, 4-bit, or 5-bit number. In specific embodiments, the branch predictor entry may comprise solely the counter and the offset. In specific embodiments, the branch predictor entry may be less than or equal to 9-bits.

In specific embodiments, the computer processor may take on various forms. For example, the computer processor could be a RISC-V processor. The computer processor may be a RISC-V processor with C-extension support. The counter and the offset form a branch predictor entry for the fetch group in a TAGE table of the branch prediction circuitry. In specific embodiments, the branch predictor entry does not have any other counters, the fetch group has a number of instructions that is at least 16, the counter and the offset form a branch predictor entry for the fetch group, the offset is less than or equal to a number of bits need to represent the number of instructions, and the branch predictor entry is less than or equal to 9 bits.

In specific embodiments of the invention, the counters and offsets disclosed herein may form a branch predictor entry for a fetch group in a table in branch predictor circuitry of a processor. The table may be a tagged geometric history length table of the branch prediction circuitry. The tagged geometric history length table may include a set of branch predictor entries. The branch predictor entries may include a counter and an offset as disclosed herein and be stored in association with a specific fetch group. Each branch predictor entry in the set of branch predictor entries may be associated with a different fetch group of the program.

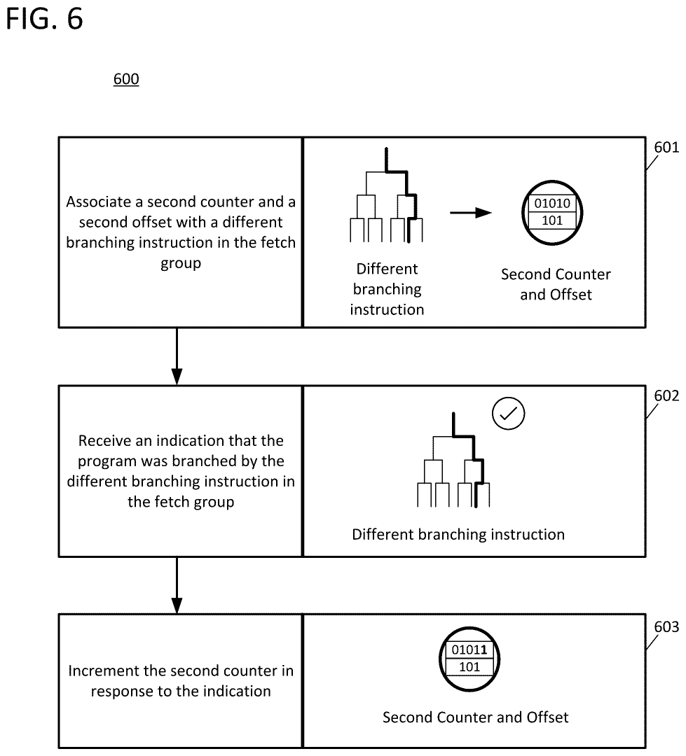

FIG. 6 provides method 600 in accordance with specific embodiments of the invention. Each step of the method may be conducted by a branch prediction circuit and an instruction fetch circuit operating in combination in a computer processor that is executing a program. Method 600 may be performed in combination with method 500. Some aspects of method 600 be performed instead of some aspects of method 500.

In specific embodiments of the invention, multiple counters and offsets may be associated with each fetch group. These embodiments may still realize a benefit over approaches which assign a different counter to each instruction so long as the number of offsets multiplied by the number of bits needed to represent every instruction in the fetch group added to the number of counters times the number of bits per counter is less than the size of the fetch group times the number of bits per counter. In approaches where different fetch groups have different numbers of branching instructions and instructions that do not lead to branching, such an approach could also be beneficial in that counters space will not be wasted for instructions that may never lead to a branch. In these embodiments, when a branch miss is detected, the counter for the associated instruction does not need to be reset to zero. If one of the multiple counters is associated with the instruction that did lead to a branch, that counter may be incremented instead. If no counter is associated with the instruction that did lead to a branch, the counter value associated with the last counter to be incremented may be reset instead. Accordingly, in specific embodiments of the invention, the methods described above may include aspects of method 600. At 601, a second counter and a second offset (e.g., the second counter and the second offset being separate from the counter and offset of method 500) may be associated with a different branching instruction (e.g., different than the branching instruction associated with method 500) in the fetch group. At 602, an indication that the program was branched by the different branching instruction in the fetch group may be received. At 603, the second counter in response to the indication may be incremented.

A processor in accordance with this disclosure can include at least one non-transitory computer readable media. The at least one processor could comprise at least one computational node in a network of computational nodes. The media could include cache memories on the processor. The media can also include shared memories that are not associated with a unique computational node. The media could be a shared memory, could be a shared random-access memory, and could be, for example, a DDR DRAM. The media could be hard coded logic that is readable and executes instructions in that signals applied to the logic produce output signals that can be read from the output of the hard coded logic. The shared memory can be accessed by multiple channels. The non-transitory computer readable media can store data required for the execution of any of the methods disclosed herein. The computer readable media can also store instructions which, when executed by the system, cause the system to execute the methods disclosed herein. The concept of executing instructions is used herein to describe the operation of a device conducting any logic or data movement operation, even if the “instructions” are specified entirely in hardware (e.g., an AND gate executes an “and” instruction). The term is not meant to impute the ability to be programmable to a device.

While the specification has been described in detail with respect to specific embodiments of the invention, it will be appreciated that those skilled in the art, upon attaining an understanding of the foregoing, may readily conceive of alterations to, variations of, and equivalents to these embodiments. Any of the method steps discussed above can be conducted by a processor operating with a computer-readable non-transitory medium storing instructions for those method steps. The computer-readable medium may be memory within a personal user device or a network accessible memory. These and other modifications and variations to the present invention may be practiced by those skilled in the art, without departing from the scope of the present invention, which is more particularly set forth in the appended claims.

What is claimed is:

1. A method, in which each step is conducted by a branch prediction circuit and an instruction fetch circuit operating in combination in a computer processor that is executing a program, comprising:
fetching a group of instructions, in a fetch group, from an instruction memory;
associating a counter and an offset with the fetch group;
predicting, using the counter and the offset, that a branching instruction in the fetch group will be used to branch the program; and
prefetching at least one instruction indicated by the branching instruction.

2. The method of claim 1, wherein:
the offset comprises sufficient bits to represent each instruction in the fetch group; and
the branching instruction is associated with a value of the offset.

3. The method of claim 1, further comprising:
receiving an indication that the program was branched by the branching instruction; and
incrementing the counter in response to the indication.

4. The method of claim 1, further comprising:
receiving an indication that the program was branched by a different branching instruction in the fetch group; and
lowering the counter in response to the indication.

5. The method of claim 1, further comprising:
receiving an indication that the program was branched by a different branching instruction in the fetch group;
modifying a hysteresis counter in response to the indication; and
comparing the hysteresis counter with a threshold.

6. The method of claim 1, wherein:
the fetch group has a number of instructions that is at least 4;
the counter and the offset form a branch predictor entry for the fetch group;
the offset is less than or equal to a number of bits required to represent the number of instructions; and
the branch predictor entry is less than or equal to 9 bits.

7. The method of claim 1, wherein:
the counter and the offset form a branch predictor entry for the fetch group in a tagged geometric history length table of the branch prediction circuit.

8. The method of claim 1, wherein:
the computer processor is a RISC-V processor with C-extension support;
the counter and the offset form a branch predictor entry for the fetch group in a tagged geometric history length table of the branch prediction circuit; and
the branch predictor entry does not have any other counters.

9. The method of claim 1, wherein:
the fetch group has a number of instructions that is at least 16;
the counter and the offset form a branch predictor entry for the fetch group;
the offset is less than or equal to a number of bits needed to represent the number of instructions; and
the branch predictor entry is less than or equal to 9 bits.

10. The method of claim 1, wherein:
the counter and the offset form a branch predictor entry for the fetch group in a tagged geometric history length table of the branch prediction circuit;
the tagged geometric history length table includes a set of branch predictor entries; and
each branch predictor entry in the set of branch predictor entries is associated with a different fetch group of the program.

11. The method of claim 1, further comprising:
associating a second counter and a second offset with a different branching instruction in the fetch group;
receiving an indication that the program was branched by the different branching instruction in the fetch group; and
incrementing the second counter in response to the indication.

12. A processor comprising:
a branch prediction circuit;
an instruction fetch circuit, wherein the instruction fetch circuit fetches a group of instructions, in a fetch group, from an instruction memory; and
a counter and an offset associated with the fetch group, wherein the counter and the offset are used to predict that a branching instruction in the fetch group will be used to branch a program, and at least one instruction indicated by the branching instruction is prefetched.

13. The processor of claim 12, wherein:
the offset comprises sufficient bits to represent each instruction in the fetch group; and
the branching instruction is associated with a value of the offset.

14. The processor of claim 12, wherein:
the counter is incremented in response to an indication that the program was branched by the branching instruction.

15. The processor of claim 12, wherein:
the processor receives an indication that the program was branched by a different branching instruction in the fetch group;
the counter is lowered in response to the indication; and
the offset is set to a second value associated with the different branching instruction.

16. The processor of claim 12, wherein:
the fetch group has a number of instructions that is at least 16;
the counter and the offset form a branch predictor entry for the fetch group;
the offset is less than or equal to a number of bits required to represent the number of instructions; and
the branch predictor entry is less than or equal to 9 bits.

17. The processor of claim 12, wherein:
the counter and the offset form a branch predictor entry for the fetch group in a tagged geometric history length table of the branch prediction circuit.

18. The processor of claim 12, wherein:
the processor is a RISC-V processor with C-extension support;
the counter and the offset form a branch predictor entry for the fetch group in a tagged geometric history length table of the branch prediction circuit; and
the branch predictor entry does not have any other counters.

19. The processor of claim 12, wherein:
the fetch group has a number of instructions that is at least 16;
the counter and the offset form a branch predictor entry for the fetch group;
the offset is less than or equal to a number of bits needed to represent the number of instructions; and
the branch predictor entry is less than or equal to 9 bits.

20. A non-transitory computer-readable medium storing instructions, which when executed by a processor cause the processor to conduct a method in which each step is conducted by a branch prediction circuit and an instruction fetch circuit operating in combination in a computer processor that is executing a program, comprising:
fetching a group of instructions, in a fetch group, from an instruction memory;
associating a counter and an offset with the fetch group;
predicting, using the counter and the offset, that a branching instruction in the fetch group will be used to branch the program; and
prefetching at least one instruction indicated by the branching instruction.

21. The non-transitory computer-readable medium of claim 20, wherein:
the offset comprises sufficient bits to represent each instruction in the fetch group; and
the branching instruction is associated with a value of the offset.
